(19) United States
(12) Patent Application Publication
(10) Pub. No.: US 2007/0141408 A1
(43) Pub. Date: Jun. 21, 2007

(54) Supplying and recirculating fuel in a fuel cell system

(76) Inventor: Daniel O. Jones, Glenville, NY (US)

Correspondence Address: TROP PRUNER & HU, PC, 1616 S. VOSS ROAD, SUITE 750, HOUSTON, TX, 77057-2631, US

(21) Appl. No.: 11/311,101

(22) Filed: Dec. 19, 2005

(51) Int. Cl. H01M 8/04

(52) U.S. Cl. 429/17; 429/34; 429/22; 429/25

(57) ABSTRACT

A technique that is usable with a fuel cell stack includes providing an ejector to combine a first fuel flow from a fuel source with an anode exhaust flow from a fuel cell stack to produce a second fuel flow to an anode inlet plenum of the fuel cell stack. The technique includes regulating communication of the first flow to the ejector based on a pressure of gas in the anode inlet plenum.

### GOVERNMENT LICENSE RIGHTS

The U.S. Government has a paid-up license in this invention and the right in limited circumstances to require the patent owner to license others on reasonable terms as provided for by the terms of Contract No. DE-SC02-03CH11137 awarded by the Department of Energy.

### BACKGROUND

The invention generally relates to supplying and recirculating fuel in a fuel cell system.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 60° Celsius (C.) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, such as a cooling subsystem, a cell voltage monitoring subsystem, a control subsystem, a power conditioning subsystem, etc. The particular design of each of these subsystems is a function of the application that the fuel cell system serves.

For purposes of ensuring that the cells of the fuel cell stack are not “starved” of fuel, the incoming fuel flow to the stack exceeds the stoichiometric ratio that is set forth in Equations 1 and 2 above. Therefore, the anode exhaust flow from the fuel cell stack contains residual fuel. For purposes of maximizing the efficiency of the fuel cell system and establishing a sufficient flow through the fuel cell stack to remove water from its flow channels, the fuel cell system may recirculate the exhaust flow back to the anode inlet of the stack. Conventionally, an exhaust gas recirculation (EGR) blower may be used for this recirculation. However, the EGR blower may significantly contribute to the overall cost of the fuel cell system.

Thus, there exists a continuing need for better ways to recirculate anode exhaust flow in a fuel cell system.

### SUMMARY

In an embodiment of the invention, a technique that is usable with a fuel cell stack includes providing an ejector to combine a first fuel flow from a fuel source with an anode exhaust flow from a fuel cell stack to produce a second fuel flow to an anode inlet plenum of the fuel cell stack. The technique includes regulating communication of the first flow to the ejector based on a pressure of gas in the anode inlet plenum.

In another embodiment of the invention, a fuel cell system includes a fuel source, a fuel cell stack, an ejector and a control subsystem. The fuel cell source provides a first fuel flow, and the fuel cell stack includes an anode inlet plenum to receive a second fuel flow and an anode outlet to provide an anode exhaust flow. The ejector combines the first fuel flow with the anode exhaust flow to produce the second fuel flow. The control subsystem regulates communication of the first flow to the ejector based on a pressure of gas in the anode inlet plenum.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a waveform of an anode gas plenum pressure illustrating control of a valve of the fuel cell system of FIG. 1 according to an embodiment of the invention.

FIG. 3 is a flow diagram depicting a technique to regulate communication of a fuel flow to a gas ejector of the fuel cell system of FIG. 1 according to an embodiment of the invention.

FIG. 4 is a more detailed flow diagram depicting a technique to regulate a fuel flow to the ejector according to an embodiment of the invention.

### DETAILED DESCRIPTION

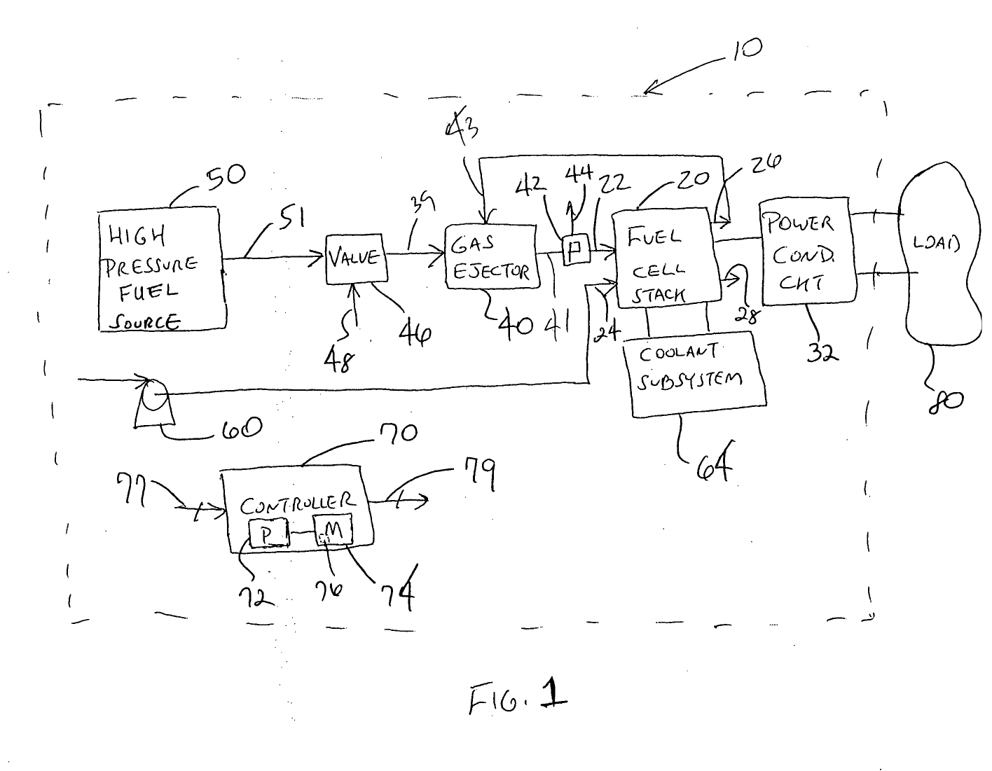

Referring to FIG. 1, in accordance with an embodiment of the invention, a fuel cell system 10 includes a fuel cell stack 20, which produces power for an external load 80 in response to incoming fuel and oxidant flows. The fuel cell stack 20 includes an anode inlet 22 that receives an incoming fuel flow and an oxidant inlet 24 that receives an incoming oxidant flow. The incoming fuel and oxidant flows are communicated inside the fuel cell stack 20 to respective anode and cathode inlet plenums of the fuel cell stack. The plenums are formed at least in part from openings in flow plates of the fuel cell stack. From these plenums, the fuel and oxidant flow through anode and cathode flow channels of the fuel cell stack 20 to promote electrochemical reactions pursuant to Equations 1 and 2 (see Background). The fuel flow produces an anode exhaust at an anode exhaust outlet 26 of the fuel cell stack 20; and the oxidant flow produces a cathode exhaust flow at a cathode outlet 28 of the stack 20.

As a result of the electrochemical reactions inside the fuel cell stack 20, the stack 20 produces power, which is conditioned into the appropriate form by power conditioning circuitry 32 for the load 80. Thus, depending on the particular embodiment of the invention, the power conditioning circuitry 32 may regulate a DC stack voltage from the fuel cell stack 20 into another regulated DC level for the load 80 (for the case where the load 80 is a DC load); and in other embodiments of the invention, the power conditioning circuitry 32 may convert the DC stack voltage into an AC voltage for the load 80 (for the case where the load 80 is an AC load). Thus, many variations are possible and are within the scope of the appended claims.

In accordance with embodiments of the invention, the fuel cell system 10 includes a gas ejector 40 for purposes of recirculating the anode exhaust flow back to the anode inlet 22 and mixing the anode exhaust flow with an incoming fuel flow from a high pressure fuel source 50. The gas ejector 40, unlike an exhaust gas recirculation (EGR) blower, is a passive device, which has a main flow path that communicates the incoming fuel flow from the high pressure fuel source 50. The main flow path extends from an inlet 39 of the gas ejector 40 to an outlet 41 of the ejector 40. In response to the communication of the fuel flow through its main flow path, the gas ejector 40 creates a pressure drop at an ejector input 43 that is connected to the anode exhaust outlet 26. This pressure drop establishes an anode exhaust recirculation flow from the anode exhaust outlet 26, to the ejector inlet 43 and into the main flow path of the ejector 40.

As a more specific example, in accordance with some embodiments of the invention, the gas ejector 40 may be a venturi; and for these embodiments of the invention, the main flow path of the gas ejector 40 may be considered the throat of the venturi, and the ejector inlet 43 is the inlet port of the venture into which a flow may be injected into the throat.

For purposes of optimizing use of the gas ejector 40, in accordance with embodiments of the invention that are described herein, the incoming fuel flow from the high pressure source 50 is regulated based on a pressure of the gas in the anode inlet plenum of the fuel cell stack 20. More particularly, in accordance with some embodiments of the invention, the fuel cell system 10 includes a controller 70 (one or more microprocessors or microcontrollers, as examples) that monitors the pressure of the gas in the anode inlet plenum (via a pressure sensor 42 and associated output signal that appears on its output terminal 44) and controls a valve 46 accordingly to regulate the flow from the high pressure fuel source 50 to the main flow path inlet 39 of the gas ejector 40.

More specifically, as further described below, the controller 70 controls the valve 46 to maintain the anode inlet plenum pressure within a regulated range. Thus, when the plenum pressure surpasses the regulated range, the controller 70 closes the valve 46; and conversely, when the plenum pressure decreases below the regulated range, the controller 70 opens the valve 46 to reestablish communication between the high pressure source 50 and the gas ejector 40 to raise the plenum pressure.

As depicted in FIG. 1, in accordance with some embodiments of the invention, the valve 46 includes at least one control terminal 48 that receives a control signal that is generated (indirectly or directly) by the controller 70 for purposes of controlling the state (open or closed) of the valve 46. The valve 46 has an input terminal that is coupled to an output terminal 51 of the high pressure fuel source 50, and the valve 46 includes an output terminal that is coupled to the main flow path inlet 39 of the gas ejector 40. As a more specific example, in accordance with some embodiments of the invention, the valve 46 may a solenoid valve, although other valves may be used in other embodiments of the invention.

The controller 70 may include, for purposes of example, a processor 72 that executes program instructions 76 (that are stored in a memory 74) for purposes of controlling the valve 46 in accordance with the techniques that are disclosed herein. The controller 70 may include input terminals 77 for purposes of receiving status signals (such as the pressure signal from the pressure sensor 42) from the fuel cell system, signals indicative of commands, etc. Furthermore, the controller 70 may include output terminals 79 for purposes of controlling various valves (such as the valve 46), motors, etc. of the fuel cell system 10 and for purposes of communicating status messages and commands to other entities.

Among the other features of the fuel cell system 10, in accordance with some embodiments of the invention, the fuel cell system 10 may include an oxidant source, such as an air blower 60, which furnishes the incoming oxidant flow to the oxidant inlet 24 of the fuel cell stack 20. In accordance with some embodiments of the invention, the fuel cell system 10 may include a cathode recirculation path. Furthermore, in accordance with some embodiments of the invention, the fuel cell system 10 may include a bleed path in the anode exhaust recirculation path; and therefore, a bleed path that is established by an orifice may be coupled to the anode exhaust outlet 26, in some embodiments of the invention. Thus, many variations are possible and are within the scope of the appended claims. Additionally, as depicted in FIG. 1, the fuel cell system 10 may include a coolant subsystem 64 that circulates a coolant through the fuel cell stack 20 for purposes of regulating the temperature of the stack 20.

In accordance with some embodiments of the invention, the high pressure source 50 may be a hydrogen tank, and in other embodiments of the invention, the high pressure fuel source may be a reformer. Thus, depending on the particular embodiment of the invention, either a hydrogen fuel flow or a reformate fuel flow may be received at the main flow path inlet 39 of the gas ejector 40, depending on the state of the valve 46. In some embodiments of the invention, the high pressure source 50 may have a pressure of 80 pounds per square inch gauge (psig), although other pressures are possible in other embodiments of the invention.

As depicted in FIG. 1, in some embodiments of the invention, the pressure sensor 42 may be coupled in the flow path of a conduit that is located between the outlet 41 of the gas ejector 40 and the anode inlet 22 of the fuel cell stack 20. In other embodiments of the invention, the pressure sensor 42 may be located inside the anode inlet plenum of the fuel cell stack 20; and in yet other embodiments of the invention, the pressure sensor 42 may be located at the outlet 41 of the gas ejector 40. Thus, many variations are possible and are within the scope of the appended claims.

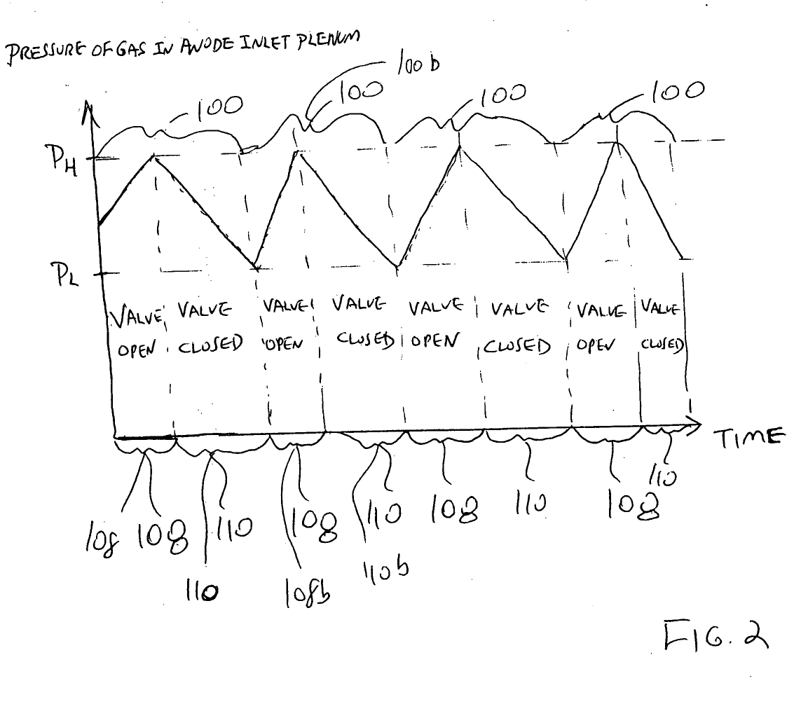

FIG. 2 depicts the anode gas plenum pressure in accordance with an embodiment of the invention and illustrates the control of the valve 46. More specifically, as depicted in FIG. 2, the valve 46 may be controlled pursuant to successive switching cycles 100. Each switching cycle 100 includes an open time 108 in which the valve 46 is open to communicate fuel from the high pressure source fuel 50 and a closed time 110 in which the valve 46 is closed to block the communication of fuel from the high pressure fuel source 50. During the open time 108, the anode inlet plenum gas pressure increases until the pressure reaches an upper pressure threshold (called “P_{H}”), at which time the open time 108 ends and the closed time 110 begins. Thus, when the anode gas plenum pressure reaches the P_{H} upper pressure threshold, the controller 70 closes the valve 46 to isolate the high pressure fuel source 50 from the anode inlet plenum.

As depicted in FIG. 2, when the valve 46 is closed, the anode gas plenum pressure decreases, a decrease that continues until the pressure reaches a lower pressure threshold (called “P_{L}” in FIG. 2) at which time the controller 70 once again opens the valve 46 to reestablish communication between the high pressure fuel source 50 and the anode inlet plenum.

Thus, as depicted in FIG. 2, the anode gas plenum pressure cycles between the P_{H} upper pressure threshold and the P_{L} lower pressure threshold so that by the above-described operation of the valve 46, the controller 70 keeps the anode inlet plenum gas pressure within a regulated range that is defined by the P_{H} and P_{L} boundaries.

The incoming fuel flow to the anode inlet 22 of the fuel cell stack 20 is relatively constant during the time when the plenum is charging with pressure (i.e., during the valve open time 108), thereby producing relatively constant anode exhaust recirculation flow when the valve 46 is open. Although the load 80 may affect the pressure, the difference between the minimum load pressure and the maximum load pressure is relatively small.

The duration of the open time 108 is dependent upon such system design parameters as the plenum volume, the P_{H} upper pressure threshold, the P_{L} lower pressure threshold and the orifice size of the gas ejector 40. To a lesser extent, the duration of the open time 108 is dependent upon the load 80.

The duration of the closed time 110 is a function of such system design parameters as the plenum volume and fuel cell volume, the load 80, the P_{H} upper pressure threshold and the P_{L} lower pressure threshold. Thus, the P_{H} upper pressure threshold and the P_{L} lower pressure threshold are selected based on system design goals and constraint.

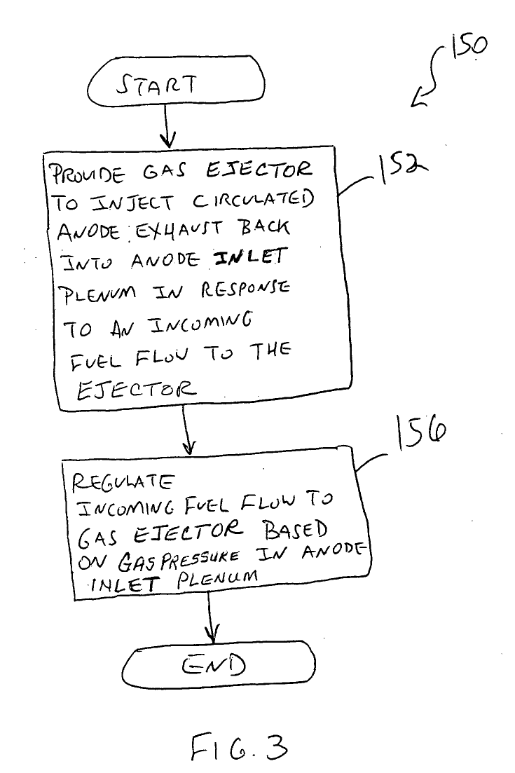

Referring to FIG. 3, to summarize, in accordance with some embodiments of the invention, a technique 150 may be used to control incoming flow to the gas ejector 40. Pursuant to the technique 150, gas is provided (block 152) to the ejector 40 so that the ejector 40 injects anode exhaust gas into the anode intake plenum in response to an incoming fuel flow to the ejector 40 from the high pressure fuel source 50. The technique 150 includes regulating (block 156) incoming fuel flow to the gas ejector based on the gas pressure in the anode inlet plenum.

The advantages of the technique 150 may include one or more of the following. A single fixed ejector may be operated acceptably with a fuel cell over a wide load range. Anode gas recirculation may be accomplished without the use of a costly gas blower. A high recirculation flow rate may be achieved, thereby effectively moving liquid water from flow plate flow channels. The energy that is present in a high pressure hydrogen source stream (i.e., energy normally lost in a pressure regulator) is used, thereby increasing system efficiency.

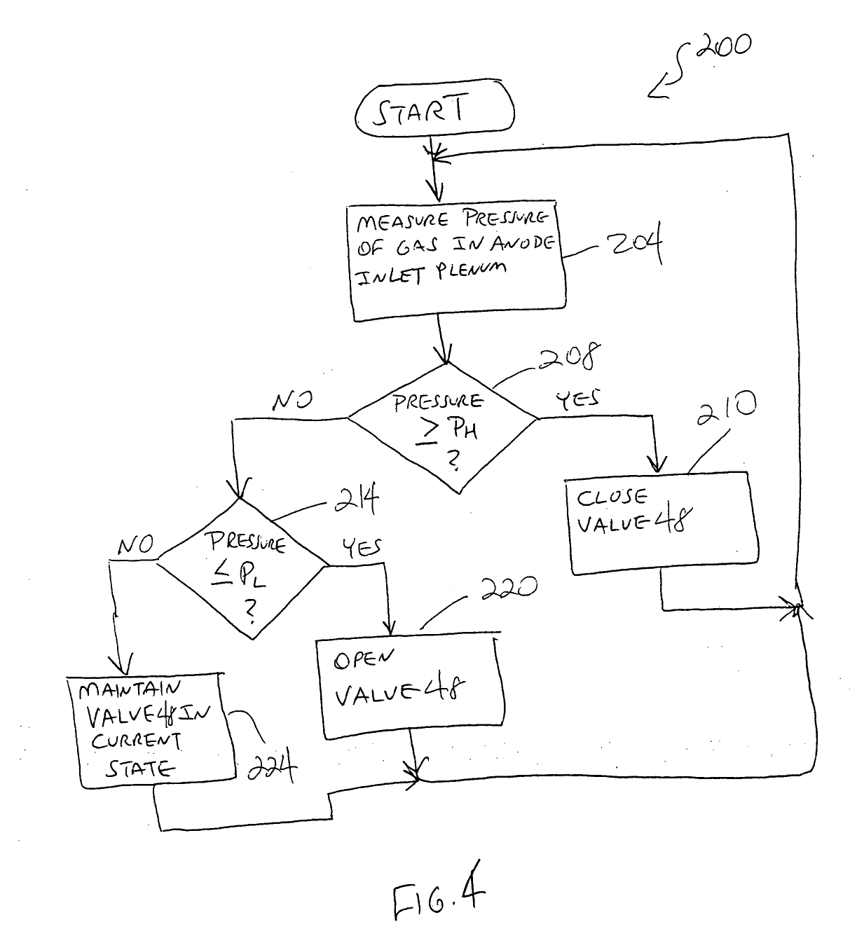

FIG. 4 depicts a more detailed technique 200 to control the valve 46 in accordance with some embodiments of the invention. Pursuant to the technique 200, the gas pressure in the anode inlet plenum is measured, pursuant to block 204. A determination is then made (diamond 208) whether the pressure in the plenum is greater than or approximately equal to the P_{H} upper pressure threshold. If so, then the valve 48 is closed, pursuant to block 210. Otherwise, a determination is made (diamond 214) whether the pressure is less than or equal to the lower pressure limit threshold. If so, then the valve 48 is open, pursuant to block 220. Otherwise, the valve 48 is maintained in its current state, as depicted in block 224.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
providing an injector to combine a first fuel flow from a fuel source with an anode exhaust flow from the fuel cell stack to produce a second fuel flow to an anode inlet plenum of the fuel cell stack; and
regulating communication of the first flow to the injector based on a pressure of gas in the anode inlet plenum.

2. The method of claim 1, wherein the act of providing comprises providing a Venturi to combine the first fuel flow with the anode exhaust flow.

3. The method of claim 1, wherein the act of regulating comprises selectively shutting on and shutting off communication of the first flow to the injector.

4. The method of claim 1, wherein the act of regulating comprises opening a valve located between the fuel source and the injector in response to the pressure decreasing to a pressure near a lower pressure threshold.

5. The method of claim 1, wherein the act of regulating comprises closing a valve located between the fuel source and the injector in response to the pressure increasing to a pressure near an upper pressure threshold.

6. The method of claim 1, wherein the act of regulating comprises selectively opening and closing a valve located between the fuel source and the injector to maintain the pressure within a regulated range.

7. The method of claim 1, wherein the act of regulating comprises:
blocking communication of the first flow through a valve located between the fuel source and the injector in response to the pressure increasing to pressure near an upper pressure threshold; and
opening communication of the first flow through the valve in response to the pressure decreasing near a lower pressure threshold.

8. The method of claim 7, further comprising:
maintaining the valve in its current state in response to the pressure being below the upper pressure threshold and above the lower pressure threshold.

9. The method of claim 1, wherein the act of providing comprises providing the fuel flow from a pressurized fuel source.

10. The method of claim 9, wherein the pressurized fuel source provided the first flow at a pressure of approximately 80 pounds per square inch gauge.

11. A fuel cell system, comprising:
a fuel source to provide a first fuel flow;
a fuel cell stack comprising an anode inlet plenum to receive a second fuel flow and an anode outlet to provide an anode exhaust flow;
an ejector to combine the first fuel flow with the anode exhaust flow to produce the second fuel flow; and
a control subsystem to regulate communication of the first flow to the injector based on a pressure of gas in the anode inlet plenum.

12. The fuel cell system of claim 11, wherein the ejector comprises a Venturi.

13. The fuel cell system of claim 11, wherein the control subsystem comprises a valve adapted to selectively shut on and shut off communication of the first flow to the ejector.

14. The fuel cell system of claim 13, wherein the valve comprises a solenoid valve.

15. The fuel cell system of claim 11, wherein the control subsystem comprises:
a valve located between the fuel source and the injector; and
a controller to open the valve in response to the pressure decreasing to a pressure near a lower pressure threshold.

16. The fuel cell system of claim 11, wherein the control subsystem comprises:
a valve located between the fuel source and the ejector; and
a controller to close the valve in response to the pressure increasing to a pressure near an upper pressure threshold.

17. The fuel cell system of claim 11, wherein the control subsystem comprises:
a valve located between the fuel source and the ejector; and
a controller to control the valve to maintain the pressure within a regulated range.

18. The fuel cell system of claim 11, wherein the control subsystem comprises:
a valve located between the fuel source and the ejector; and
a controller to block communication of the first flow through the valve in response to the pressure increasing to pressure near an upper pressure threshold and open communication of the first flow through the valve in response to the pressure decreasing near a lower pressure threshold.

19. The fuel cell system of claim 18, wherein the controller is adapted to maintain the valve in its current state in response to the pressure being below the upper pressure threshold and above the lower pressure threshold.

20. The fuel cell system of claim 11, wherein the fuel source comprises a pressurized fuel source.

21. The fuel cell system of claim 20, wherein the pressurized fuel source is adapted to provide the first flow at a pressure of approximately 80 pounds per square inch gauge.
